(19) United States
(12) Patent Application Publication
(10) Pub. No.: US 2025/0251016 A1
(43) Pub. Date: Aug. 7, 2025

(54) ANGLE-ADJUSTABLE FIXING STRUCTURE

(71) Applicant: ABILITY ENTERPRISE CO., LTD., New Taipei City (TW)

(72) Inventors: Che-Jen HSU, New Taipei (TW); Cheng-Kuang TSENG, New Taipei City (TW); Yung-Tseng YEN, New Taipei City (TW); Chang-Hsiao CHI, New Taipei City (TW)

(21) Appl. No.: 19/034,945

(22) Filed: Jan. 23, 2025

(30) Foreign Application Priority Data
Feb. 1, 2024 (TW) 113201264

(51) Int. Cl. F16C 11/10; F16C 11/06

(52) U.S. Cl. CPC F16C 11/103; F16C 11/0695

(57) ABSTRACT

An angle-adjustable fixing structure includes a body, a base, an adjustment member, a block, an elastic member and a locking member. The body includes an inclined surface. The base includes an abutment surface and inserts into the body. The adjustment member is on the base. The block is between the inclined surface and the abutment surface. The elastic member is between the block and the body. The locking member inserts into the elastic member and locks the block. The block slides via the inclined surface for the base and the body tightening or loosening the adjustment member by variations of a locking depth of the locking member.

This application claims the benefit of Taiwan Application No. 113201264, filed Feb. 1, 2024, the subject matter of which is incorporated herein by reference.

### BACKGROUND OF THE INVENTION

### Field of the Invention

The invention relates in general to a fixing structure, and more particularly to an angle-adjustable fixing structure.

### Description of the Related Art

Many products in our daily lives utilize adjustable angle fixing structures to meet diverse usage requirements. For instance, cameras require different shooting angles based on their focal length, orientation, the structure of the object they are attached to, and the desired image composition. Therefore, cameras need to be mounted on a fixed object through an angle-adjustable fixing structure to allow for quick adjustments and meet user needs.

However, while adjusting the angle, the user often feels a lot of inconvenience due to complicated operation steps or the need to use multiple tools.

### SUMMARY OF THE INVENTION

In view of the shortcomings of the existing technology, the present invention provides an angle-adjustable fixing structure. The angle of the adjustment member can be adjusted by relaxing the adjustment member, and the adjustment member can be fixed by tightening the adjustment member.

In order to achieve the above purpose, the present invention provides an angle-adjustable fixing structure. The angle-adjustable fixing structure includes a body, a base, an adjustment member, a block, an elastic member and a locking member. The body includes an inclined surface. The base includes an abutment surface and inserts into the body. The adjustment member is on the base. The block is between the inclined surface and the abutment surface. The elastic member is between the block and the body. The locking member inserts into the elastic member and locks the block. The block slides via the inclined surface for the base and the body tightening or loosening the adjustment member by variations of a locking depth of the locking member.

According to an embodiment, an angle-adjustable fixing structure includes a base, a body, an adjustment member, a block, an elastic member and a locking member. The base includes a first pivot portion and an abutment surface. The body includes a second pivot portion and an inclined surface. The base inserts into the body. The adjustment member includes an arc-shaped body. The adjustment member is on the base. The arc-shaped body is between the first pivot portion and the second pivot portion. The block is between the inclined surface and the abutment surface. The elastic member is between the block and the body. The locking member inserts into the elastic member and locks the block.

According to an embodiment, an angle-adjustable fixing structure includes a body, a base, an adjustment member, a block and a locking member. The body includes an inclined surface. The base includes an abutment surface. The base inserts into the body. The adjustment member is on the base. The block is between the inclined surface and the abutment surface. The locking member locks the block. The block slides via the inclined surface by variations of a locking depth of the locking member.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an exploded view of an angle-adjustable fixing structure according to an embodiment of the present invention.

FIG. 2 is a three-dimensional (3D) view of the fixing structure of FIG. 1.

FIG. 3 is a 3D view omitting the adjustment member in FIG. 2.

FIG. 4 is a schematic view of a first cover of the fixing structure of FIG. 1.

FIG. 5 is a schematic view of a base of the fixing structure of FIG. 1.

FIG. 6 is a 3D cross-sectional view of the fixing structure of FIG. 2.

FIG. 7 is a schematic cross-sectional view of the fixing structure of FIG. 2 taken along section line 7-7′, showing that an arc-shaped body is in a tight state.

FIG. 8 is a schematic cross-sectional view of the fixing structure, showing the arc-shaped body in a relaxed state.

FIG. 9 is a schematic 3D cross-sectional view of the fixing structure, showing the adjustment member in a second position.

### DETAILED DESCRIPTION OF THE INVENTION

Each embodiment of the present invention will be described in detail below, and the drawings will be used as illustrations. In addition to these detailed descriptions, the present invention can also be widely implemented in other embodiments. Easy substitutions, modifications, and equivalent changes of any of the embodiments are included in the scope of the present invention, and the scope of the present invention depends on the subsequent claims. In the description of the specification, many specific details and implementation examples are provided to enable readers to have a more complete understanding of the present invention; however, these specific details and implementation examples should not be regarded as limitations of the present invention. In addition, well-known steps or components are not described in detail to avoid unnecessary limitations of the present invention.

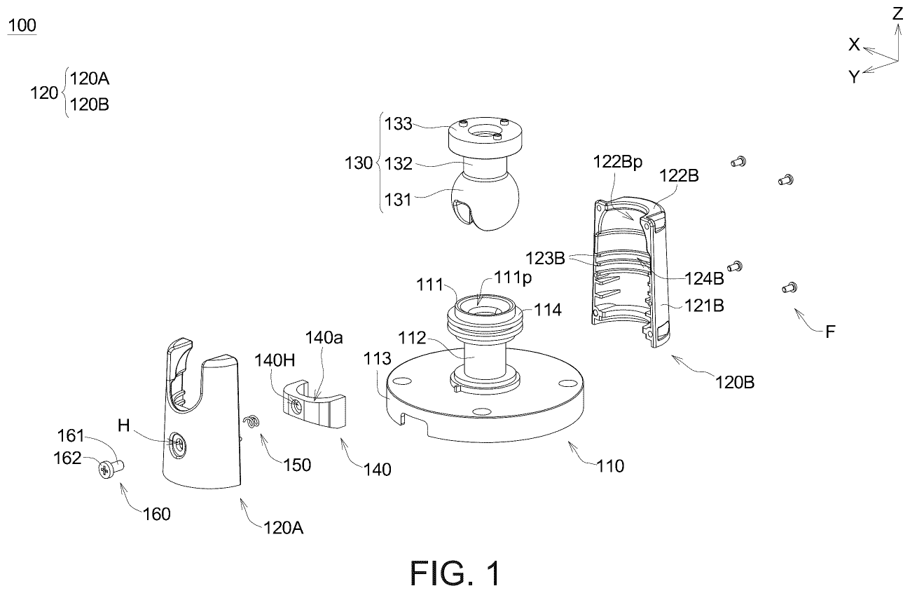

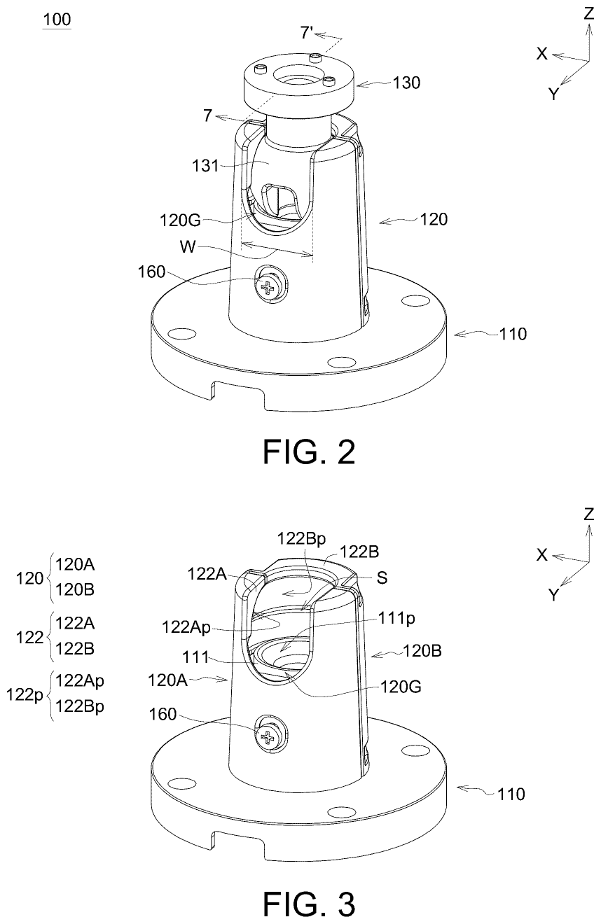

FIG. 1 is an exploded view of an angle-adjustable fixing structure 100 according to an embodiment of the present invention. FIG. 2 is a three-dimensional (3D) view of the fixing structure 100 of FIG. 1.

Please refer to FIGS. 1 and 2. The angle-adjustable fixing structure 100 at least includes a base 110, a body 120, an adjustment member 130, a block 140, an elastic member 150 and a locking member 160. The body 120 may include a first cover 120A and a second cover 120B, and the first cover 120A and the second cover 120B may be combined to form a tubular space. The first cover 120A and the second cover 120B can be relatively fixed by screws F, and/or relatively buckled or adhesively fixed through structural design, and the present invention is not limited thereto.

The base 110 may include a first pivot portion 111, a first shaft portion 112 and a first connecting portion 113. The first shaft portion 112 connects to the first pivot portion 111 and the first connecting portion 113. The adjustment member 130 may include an arc-shaped body 131, a second shaft portion 132 and a second connecting portion 133. The second shaft portion 132 connects to the arc-shaped body 131 and the second connecting portion 133. The adjustment member 130 is on the base 110, and the base 110 and the adjustment member 130 can insert into the body 120. The first pivot portion 111 of the base 110 and the arc-shaped body 131 of the adjustment member 130 are in the tubular space of the body 120, and the first connecting portion 113 and the second connecting portion 133 respectively expose at both ends of the body 120. Therefore, if an independent first component (not shown) and an independent second component (not shown) fix to the first connecting portion 113 and the second connecting portion 133 respectively, the first component and the second component can connect through the fixing structure 100. On the other hand, the first component and the second component can rotate relative to the body 120 through the base 110 and the adjustment member 130, and can be at a certain angle arbitrarily. For example, the first component can be a wall, a column, a ceiling or a large object, and the second component can be a camera device. The camera device can connects to the wall, column, ceiling or large object through the fixing structure 100 and the orientation of the camera can change along with the user's requirement, but the present invention is not limited to this.

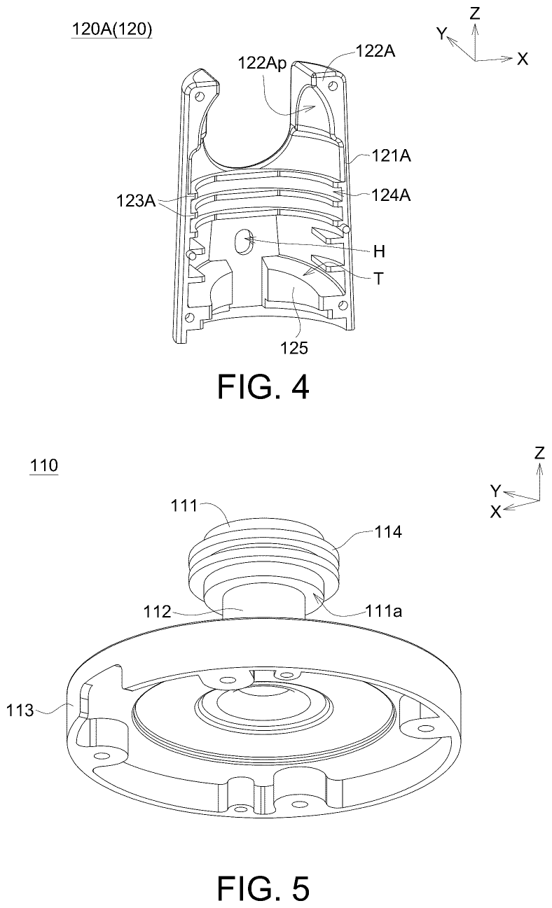

FIG. 3 is a 3D view omitting the adjustment member 130 in FIG. 2. FIG. 4 is a schematic view of the first cover 120A of the fixing structure 100 of FIG. 1.

Referring to FIGS. 1, 3 and 4, the body 120 may include a second pivot portion 122. The first cover 120A may include a first cover body 121A and a first sub-pivot portion 122A. The first sub-pivot portion 122A is above the first cover body 121A (in a positive direction of Z-axis), and the first sub-pivot portion 122A has a first inner arc surface 122Ap. The second cover 120B may include a second cover body 121B and a second sub-pivot 122B. The second sub-hub portion 122B is above the second cover body 121B (in the positive Z-axis direction) and has a second inner arc surface 122Bp. While the first cover 120A joins and fixes to the second cover 120B, the first sub-pivot portion 122A of the first cover 120A and the second sub-pivot portion 122B of the second cover 120B can combine to form a second pivot portion 122 of the body 120. The first inner arc surface 122Ap of the first sub-pivot portion 122A and the second inner arc surface 122Bp of the second sub-pivot portion 122B may form an arc-shaped inner surface, and the arc-shaped inner surface is a second pivot surface 122p of the second pivot portion 122.

Please refer to FIGS. 1, 2 and 3. While the base 110 is in the tubular space of the body 120, a spherical space S can be between the first pivot portion 111 of the base 110 and the second pivot portion 122 of the body 120. An arc-shaped body 131 of the adjustment member 130 is in the spherical space S between the first pivot portion 111 of the base 110 and the second pivot portion 122 of the body 120. The first pivot portion 111 of the base 110 may have a first pivot surface 111p. The first pivot surface 111p and the second pivot surface 122p connect to the arc-shaped body 131 of the adjustment member 130, and the shape can be commensurate with the arc-shaped body 131 of the adjustment member 130, so that the arc-shaped body 131 can closely attach to the first pivot surface 111p and the second pivot surface 122p.

Referring to FIGS. 1 and 4, the first cover 120A may further include at least two first ribs 123A, disposed along the Z-axis and formed on the inner surface of the first cover body 121A. A first guide groove 124A can be between the at least two first ribs 123A. Correspondingly, the second cover 120B may also include at least two second ribs 123B, disposed along the Z-axis and form on the inner surface of the second cover body 121B. A second guide groove 124B can be between the at least two second ribs 123B.

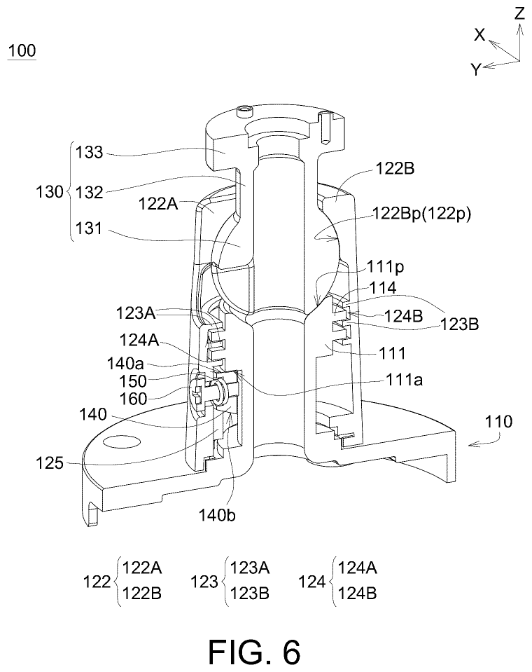

FIG. 5 is a schematic view of the base 110 of the fixing structure 100 of FIG. 1. FIG. 6 is a schematic 3D cross-sectional view of the fixing structure 100 of FIG. 2.

Please refer to FIGS. 5 and 6. While the first cover 120A joins and fixes to the second cover 120B, the first ribs 123A and the second ribs 123B can butt with each other to form ribs 123 of the body 120. The first guide grooves 124A and the second guide grooves 124B can connect to each other to form guide grooves 124 of the body 120. Base 110 may further include flanges 114. The flanges 114 protrude from a side surface of the first pivot portion 111 and are in the guide grooves 124 of the body 120. The base 110 can be on the body 120 by means of the flanges 114 and the guide grooves 124 so that the base 110 will not fall off the body 120 in the negative direction of the Z-axis.

Referring to FIG. 4, the body 120 may have an inclined surface T. In one embodiment, the first cover 120A may further include a limiting portion 125. The limiting portion 125 is formed on the inner surface of the first cover body 121A, and the inclined surface T is on the limiting portion 125.

Referring to FIGS. 1, 4, 5 and 6, the base 110 may have an abutment surface 111a. In one embodiment, the abutment surface 111a is on the first pivot portion 111, and the abutment surface 111a and the first pivot surface 111p are respectively located on opposite sides of the first pivot portion 111. The abutment surface 111a is parallel to the XY plane, and the inclined surface T forms an angle with the XY plane and extends obliquely downward in the negative direction of the Z axis. The block 140 is located between the first pivot portion 111 of the base 110 and the limiting portion 125 of the first cover 120A. Furthermore, the block 140 is disposed between the abutment surface 111a and the inclined surface T, and the upper surface 140a of the pushing block 140 cooperates with the abutment surface 111a, and the lower surface 140b of the block 140 cooperates with the inclined surface T. Therefore, the upper surface 140a and the lower surface 140b of the block 140 can abut against the abutment surface 111a and the inclined surface T, respectively. If the block 140 moves in the positive direction of the Y-axis, the block 140 will be guided by the inclined surface T, and will drive the base 110 to move in the positive direction of the Z-axis toward the arc-shaped body 131 of the adjustment member 130, so that the arc-shaped body 131 is in a tight state relative to the first pivot portion 111 and the second pivot portion 122; if the block 140 moves in the negative direction of the Y-axis, the block 140 will be guided by the inclined surface T, and will drive the base 110 to move in the negative direction of the Z-axis away from the arc-shaped body 131 of the adjustment member 130, so that the arc-shaped body 131 is in a relaxed state relative to the first pivot portion 111 and the second pivot portion 122.

Referring to FIGS. 1, 4 and 6, an elastic member 150 is between the block 140 and the body 120 (such as the first cover 120A). In one embodiment, the elastic member 150 is a compression spring. If the block 140 moves in the positive direction of the Y-axis, the elastic member 150 will be compressed to store elastic force.

Referring to FIGS. 1, 4 and 6, a locking member 160 has a threaded portion 161 and a head 162, and the locking member 160 inserts into the elastic member 150 and locks the block 140. The body 120 (such as the first cover 120A) may have a through hole H. An inner diameter of the through hole H is larger than the threaded portion 161 of the locking member 160, but smaller than the head 162 of the locking member 160, so the threaded portion 161 can extend into the body 120. In contrast, the block 140 can have a screw hole 140H, and the threaded portion 161 of the locking member 160 can inserts into the through hole H and the elastic member 150 in sequence and then be locks in the screw hole 140H.

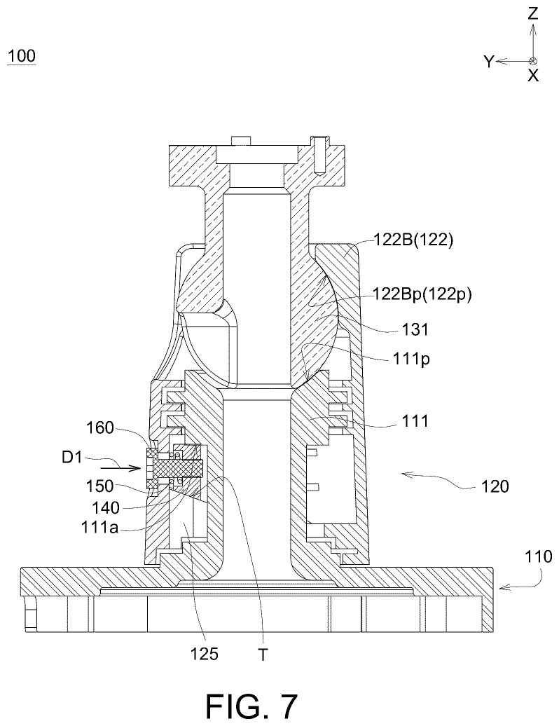

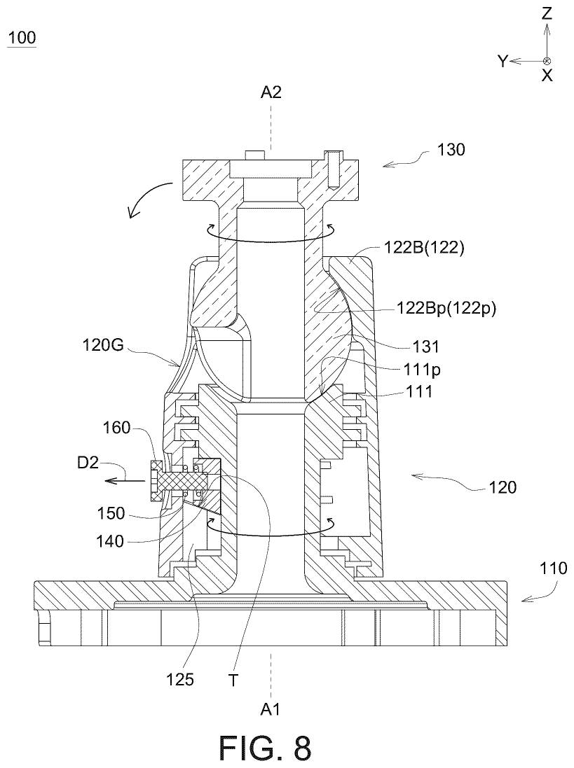

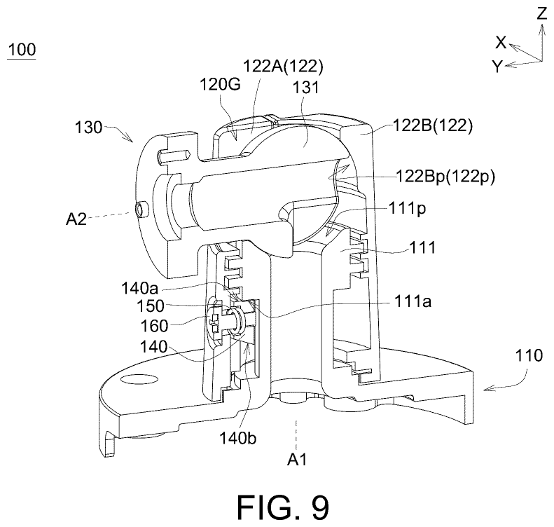

FIG. 7 is a schematic cross-sectional view of the fixing structure 100 of FIG. 2 taken along section line 7-7′, showing the arc-shaped body 131 in a tight state. FIG. 8 is a schematic cross-sectional view of the fixing structure 100, showing the arc-shaped body 131 in a relaxed state. FIG. 9 is a schematic 3D cross-sectional view of the fixing structure 100.

Referring to FIGS. 7 and 8, the locking member 160 can move in a locking direction D1 or an unlocking direction D2 while being locked on the block 140. The locking direction D1 and the unlocking direction D2 are parallel to the Y-axis. The block 140 can slide along the inclined surface T by the different locking depths of the locking member 160 on the block 140, thereby driving the base 110 to move toward or away from the arc-shaped body 131 to adjust the degree of tightness of the first pivot portion 111 and the second pivot portion 122 to the arc-shaped body 131, and causing the body 120 to tighten or loosen the adjustment member 130.

As shown in FIG. 7, in the process of the locking member 160 moving in the locking direction D1, the deeper the locking depth of the locking member 160 to the block 140 will cause the block 140 to move in the positive direction of the Y-axis, and the base 110 is driven to move in the positive direction of the Z-axis toward the arc-shaped body 131 of the adjustment member 130 through the guidance of the inclined surface T, so that the arc-shaped body 131 is in a tight state relative to the first pivot portion 111 and the second pivot portion 122. While the locking member 160 deeply locks the block 140, the arc-shaped body 131 can fasten between the first pivot portion 111 and the second pivot portion 122. At this time, the arc-shaped body 131 closely abuts the first pivot surface 111p of the first pivot portion 111 and the second pivot surface 122p of the second pivot portion 122. The base 110 and the adjustment member 130 are fixed relative to the body. 120, and the elastic member 150 stores elastic force due to being compressed.

Please refer to FIG. 8. If it is desired to adjust the rotation angle of the base 110 and the adjustment member 130 relative to the body 120, move the locking member 160 toward the unlocking direction D2. During the movement of the locking member 160 in the unlocking direction D2, the shallower the locking depth of the locking member 160 to the block 140, the block 140 can move in the negative direction of the Y-axis by the elastic force stored in the elastic member 150, and the base 110 is driven to move in the negative direction of the Z-axis away from the arc-shaped body 131 of the adjustment member 130 through the guidance of the inclined surface T, so that the arc-shaped body 131 is in a relaxed state relative to the first pivot portion 111 and the second pivot portion 122. At this time, there is a gap between the arc-shaped body 131 and the second pivot surface 122p of the second pivot portion 122, so that the base 110 and the adjustment member 130 have space for movement relative to the body 120. In this way, the base 110 can rotate relative to the body 120 along a first axis A1 in the Z-axis direction; and the arc-shaped body 131 is rotatable between the first pivot portion 111 and the second pivot portion 122, so that the adjustment member 130 can rotate relative to the body 120 along a second axis A2 as the rotation axis, and/or the adjustment member 130 can change the pitch angle relative to the body 120 on the YZ plane. Accordingly, the second axis A2 and the first axis A1 can intersect each other in different directions, or the second axis A2 can be in the same direction as the first axis A1.

Referring to FIGS. 2 and 3, the body 120 may have a trench 120G, and the trench 120G connects to the spherical space S. The adjustment member 130 inserts into the trench 120G. A width W of the trench 120G is smaller than an outer diameter of the arc-shaped body 131, so the adjustment member 130 will not fall off the body 120 in the positive direction of the Z-axis. While the arc-shaped body 131 is in the relaxed state as shown in FIG. 8, the adjustment member 130 can adjust the pitch angle between a first position and a second position of the trench 120G.

Please refer to FIGS. 7 to 9. In FIGS. 8, the adjustment member 130 is in the first position, and the first axis A1 and the second axis A2 are in the same direction. In FIG. 9, the adjustment member 130 is in the second position, and the first axis A1 and the second axis A2 intersect each other. After the adjustment of rotation angle of the base 110 and the adjustment member 130 relative to the body 120 completes, the locking member 160 moves toward the locking direction D1, so that the arc-shape body 131 is in a tight state to fix the rotation angle of the base 110 and the adjustment member 130 relative to the body 120.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An angle-adjustable fixing structure, comprising:
a body comprising an inclined surface;
a base comprising an abutment surface and the base inserting into the body;
an adjustment member, being on the base;
a block, being between the inclined surface and the abutment surface;
an elastic member, being between the block and the body; and
a locking member, inserting into the elastic member and locking the block, and the block sliding via the inclined surface for the base and the body tightening or loosening the adjustment member by variations of a locking depth of the locking member.

2. The angle-adjustable fixing structure according to claim 1, wherein the base further comprises a first pivot portion, the body further comprises a second pivot portion, the adjustment member further comprises an arc-shaped body being between the first pivot portion and the second pivot portion; while the locking member deeply locks the block, the arc-shaped body fastens between the first pivot portion and the second pivot portion.

3. The angle-adjustable fixing structure according to claim 2, wherein, while the adjustment member is in a relaxed state, the arc-shaped body is rotatable between the first pivot portion and the second pivot portion.

4. The angle-adjustable fixing structure according to claim 2, wherein the body further comprises a trench, and the adjustment member inserting into the trench; while the adjustment member is in a relaxed state, an angle between a first position and a second position of the trench is adjustable by the adjustment member.

5. The angle-adjustable fixing structure according to claim 4, wherein a width of the trench is smaller than an outer diameter of the arc-shaped body.

6. The angle-adjustable fixing structure according to claim 4, wherein the base has a first axis, and the adjustment member has a second axis; while the adjustment member is at the first position, the first axial and the second axis are in the same direction; while the adjustment member is at the second position, the first axis and the second axis intersect.

7. The angle-adjustable fixing structure according to claim 1, wherein, while the adjustment member is in a relaxed state, the base is rotatable relative to the body.

8. The angle-adjustable fixing structure according to claim 1, wherein the base further comprises a flange, the body further comprises a guide groove, and the flange is in the guide groove.

9. The angle-adjustable fixing structure according to claim 1, wherein the base further comprises a first pivot portion, the adjustment member further comprises an arc-shaped body, and the first pivot portion has a first pivot surface connects to the arc-shaped body, and the first pivot surface and the abutment surface are respectively on opposite sides of the first pivot portion.

10. The angle-adjustable fixing structure according to claim 1, wherein the inclined surface forms an angle relative to a locking direction of the locking member, and the inclined surface extends downwardly relative to the locking member.

11. An angle-adjustable fixing structure, comprising:
a base comprising a first pivot portion and an abutment surface;
a body comprising a second pivot portion and an inclined surface, and the base inserting into the body;
an adjustment member comprising an arc-shaped body, the adjustment member being on the base, and the arc-shaped body being between the first pivot portion and the second pivot portion;
a block being between the inclined surface and the abutment surface;
an elastic member being between the block and the body; and
a locking member inserting into the elastic member and locking the block.

12. The angle-adjustable fixing structure according to claim 11, wherein, while the locking member deeply locks the block, the arc-shaped body fastens between the first pivot portion and the second pivot portion.

13. The angle-adjustable fixing structure according to claim 11, wherein, while the locking member gradually locks the block, the block slides on the inclined surface, and the base and the body gradually clamp the adjustment member; and/or while the adjustment member is in a relaxed state, the arc-shaped body is rotatable between the first pivot portion and the second pivot portion.

14. The angle-adjustable fixing structure according to claim 11, wherein the body further comprises a trench, and the adjustment member inserts into the trench.

15. An angle-adjustable fixing structure, comprising:
A body comprising an inclined surface;
A base comprising an abutment surface, the base inserting into the body;
an adjustment member being on the base;
a block being between the inclined surface and the abutment surface;
a locking member locking the block, and the block sliding via the inclined surface by variations of a locking depth of the locking member.

16. The angle-adjustable fixing structure according to claim 15, wherein, while the locking member deeply locks the block, the adjustment member fastens to the body and the base; and/or while the locking member and the block are unfastened, and the adjustment member is in a relaxed state, the adjustment member is rotatable between the body and the base.

17. The angle-adjustable fixing structure according to claim 15, wherein the body further comprises a trench, and the adjustment member inserts into the trench; while the locking member and the block are unfastened and the adjustment member is in a relaxed state, an angle between a first position and a second position of the trench is adjustable by the adjustment member.

18. The angle-adjustable fixing structure according to claim 15, wherein, while the locking member and the block are unfastened and the adjustment member is in a relaxed state, the base is rotatable relative to the body.

19. The angle-adjustable fixing structure according to claim 15, wherein the base further comprises a flange, the body further comprises a guide groove, and the flange is in the guide groove.

20. The angle-adjustable fixing structure according to claim 15, wherein the base further comprises a first pivot portion, the adjustment member further comprises an arc-shaped body, and the first pivot portion has a first pivot surface connecting to the arc-shaped body, and the first pivot surface and the abutment surface are respectively on opposite sides of the first pivot portion.
